(19) United States
(12) Patent Application Publication
(10) Pub. No.: US 2026/0370655 A1
(43) Pub. Date: Nov. 19, 2026

(54) JUST IN TIME ACCESS CONTROL FOR NODES ON A PRIVATE NETWORK

(71) Applicant: Tailscale Inc., Toronto (CA)

(72) Inventors: Tinku Thomas, Buckingham (EN); Anton Tolchanov, London (EN); Kristoffer Andreas Breiland Dalby, Leiden (NL); Paul Scott, London (EN)

(21) Appl. No.: 19/677,436

(22) Filed: May 14, 2026

Related U.S. Application Data
(60) Provisional application No. 63/805,698, filed on May 14, 2025.

(51) Int. Cl. H04L 9/40

(52) U.S. Cl. CPC H04L 63/108

(57) ABSTRACT

The technology disclosed herein enables just-in-time resource access using attribute-based network partitioning. In a particular example, a method includes, in an access control service for the private network, determining an attribute signifying an associated node has access to a resource on the private network. In response to determining a node on the private network is allowed to access the resource for a defined period, the method includes assigning the attribute to the node. Upon reaching the defined period after assigning the attribute to the node, the method includes removing the attribute from the node.

### RELATED APPLICATIONS

This application is related to and claims priority to U.S. Provisional Patent Application 63/805,698, titled “JUST IN TIME ACCESS CONTROL FOR NODES ON A PRIVATE NETWORK,” filed May 14, 2025, and which is hereby incorporated by reference in its entirety.

### BACKGROUND

Organizations increasingly rely on private networks to control communications between distributed computing systems, applications, and data resources. Within these environments, access to resources is typically governed through combinations of identity-based authentication, network segmentation, and policy-driven authorization frameworks. These mechanisms often depend on relatively static configurations, such as predefined roles, long-lived permissions, or fixed access control lists that determine which nodes or users are permitted to communicate with particular resources. As private networks expand across cloud, on-premises, and hybrid deployments, the number of nodes and the diversity of resources they access can grow significantly, introducing additional complexity in maintaining consistent and accurate access control policies.

Managing access within such environments can present practical challenges. Permissions granted to enable a particular task or operational need may persist longer than intended, and revoking access may involve manual updates across multiple policy components or coordination between disparate systems. Access decisions may also depend on contextual information, such as user approvals, device characteristics, or workflow-based communications occurring through external platforms that are not directly integrated into the network’s access control mechanisms. As a result, aligning transient operational activities with underlying access control enforcement can involve multiple steps, indirect signals, and reliance on processes that vary across organizational implementations.

### SUMMARY

The technology disclosed herein enables just-in-time resource access using attribute-based network partitioning. In a particular example, a method includes, in an access control service for the private network, determining an attribute signifying an associated node has access to a resource on the private network. In response to determining a node on the private network is allowed to access the resource for a defined period, the method includes assigning the attribute to the node. Upon reaching the defined period after assigning the attribute to the node, the method includes removing the attribute from the node.

In another example, an apparatus is provided having one or more computer‑readable storage media and one or more processing systems operatively coupled with the one or more computer‑readable storage media. Program instructions stored on the one or more computer‑readable storage media, when read and executed by the one or more processing systems, direct the apparatus to distribute access rules to nodes on the private network. The access rules indicate which attributes, when assigned to a given node, enable access to which of the resources. The program instructions further direct the apparatus to distribute factual attributes about a first node on the private network to other nodes on the private network. The other nodes apply the access rules to the factual attributes to determine a first resource set of the resources to which the first node is allowed access. In response to being notified that the first node is allowed temporary access to a resource not in the first resource set, the program instructions direct the apparatus to inform the other nodes about a control attribute assigned to the first node. A corresponding access rule of the access rules enables access to the resource. Upon satisfaction of a temporary-access criterion, the program instructions direct the apparatus to inform the other nodes that the control attribute is no longer assigned to the first node.

In a further example, a method includes distributing access grants to nodes on the private network. The access grants define for the nodes which node attributes enable access to which resources. The method also includes determining a user of a first node on the private network is requesting access to a resource provided by a second node on the private network. The first node is assigned one or more attributes that do not enable access to the resource according to the access grants. In response to determining the user is allowed to access the resource until a satisfaction of a criterion, the method includes assigning a control attribute to the first node. An access grant of the access grants indicates nodes with the control attribute are allowed to access the resource. In response to determining the criterion is satisfied, the method includes removing the control attribute from the first node.

### BRIEF DESCRIPTION OF THE DRAWINGS

FIGS. 1 illustrates an implementation for controlling access of nodes to resources of a private network.

FIG. 2 illustrates an operation to control access of nodes to resources of a private network.

FIG. 3 illustrates an operation to control access of nodes to resources of a private network.

FIG. 4 illustrates an operational scenario for controlling access of nodes to resources of a private network.

FIGS. 5 illustrates an implementation for controlling access of nodes to resources of a private network.

FIG. 6 illustrates an operational scenario for controlling access of nodes to resources of a private network.

FIG. 7 illustrates an operational scenario for controlling access of nodes to resources of a private network.

FIG. 8 illustrates an operational scenario for controlling access of nodes to resources of a private network.

FIG. 9 illustrates an operational scenario for controlling access of nodes to resources of a private network.

FIG. 10 illustrates an operational scenario for controlling access of nodes to resources of a private network.

FIG. 11 illustrates an operational scenario for controlling access of nodes to resources of a private network.

FIG. 12 illustrates a computing system for controlling access of nodes to resources of a private network.

### DETAILED DESCRIPTION

The examples below describe an access control service providing a Just-in-Time (JIT) Network Access solution designed to enhance security, streamline workflows, and ensure compliance with industry regulations. The access control service dynamically grants and revokes time-limited, role-based access to sensitive resources, thereby reducing the risk of unauthorized access and eliminating standing privileges. This approach leverages device posture management capabilities and integrates seamlessly with existing workflows, such as Slack Workflows and GitHub Actions.

In practice, the access control service works by allowing administrators to assign temporary custom attributes to nodes (e.g., computing devices) on a private network. For example, an Information Technology (IT) administrator can grant a contractor elevated access to a specific resource for a limited duration, such as one hour. Once the specified time expires, the elevated access is automatically revoked, ensuring that the contractor no longer has access to the sensitive resource. This process may be audit-logged, providing transparency and security for all access grants and expirations.

The access control service uses a native Application Programming Interface (API) already used by the private network for other purposes to perform temporary access management. Unlike traditional methods that rely on third-party tools, this solution is integrated directly into the private network’s existing ecosystem, reducing complexity and cost for organizations. Furthermore, the access control service can provide a more streamlined user experience. Users can submit access requests via user communication services, such as Slack, specifying the resource, duration, and approver. Upon approval, access can be instantly granted, allowing users to perform their tasks efficiently without compromising security. If access logs are enabled, security teams can also view audit logs of all access grants and expirations, ensuring transparency and accountability.

The access control service relies on the mechanisms that implement a private overlay network. A private overlay network is a network built on top of an existing physical network infrastructure (e.g., network interfaces, routers, switches, links, etc.), but with a virtual layer that creates a private and secure communication environment between devices. In an overlay network, connected devices (often referred to as nodes of the private network) can communicate as if they were on a dedicated, isolated physical network, even though they are using a public or shared underlying network. This may be achieved through software-defined networking (SDN) and protocols that allow for greater flexibility, security, and control over the communication traffic that flows between the nodes. Overlay networks are commonly used in virtual private networks (VPNs), distributed systems, and cloud environments to segment traffic, ensuring privacy and performance despite the underlying network's potential vulnerabilities.

Packet encapsulation is a key feature enabling a private overlay network. When data is sent from one node to another within the overlay, the original data packet (often called the payload) is “wrapped” within another, outer packet. This outer packet is constructed according to the rules of the overlay network's protocol, allowing it to be transmitted securely across the public network or the physical infrastructure. For instance, the original data packet may include a header directing the packet to a network address of a device on the private network. Encapsulating the original packet may encrypt the original packet using keys known only to nodes on the private network and then adding a new packet header directing the encrypted data to a public network address for the device. The encapsulation serves two purposes: it provides a secure tunnel for the data, ensuring that the packet can travel without being intercepted or altered by unauthorized entities, and it abstracts the details of the underlying physical network, enabling the overlay network to operate independently of it. Once the packet reaches the destination node, the encapsulation is removed (e.g., the encapsulated packet header is removed and the data is decrypted), and the original payload is processed.

To ensure secure communication and prevent unauthorized access, devices joining the private overlay network must authenticate themselves as valid nodes. This authentication process typically involves using cryptographic techniques, such as digital certificates or pre-shared keys, to verify the identity of each node before it can participate in the overlay. In some cases, a public key infrastructure (PKI) may be used, where each node has a unique cryptographic key pair (public and private keys) to prove its identity to other nodes on the network. In some examples, an Identity Provider (IDP) may be responsible for validating user identities and providing the necessary credentials or tokens for users to access protected systems and services. Once authenticated, nodes can encapsulate and exchange data packets for the private network.

The private networks described below also use node attributes to manage communications between nodes. The attributes may indicate a device type of the node (e.g., whether the node is a server, tablet, phone, etc.), an operating system version of the node, a location of the node, or any other information that may be relevant to managing the private network. A private network may use rules, such as those described in a Network Access Control List (ACL), to indicate which attributes enable a node to have access (or what type of access, such as read only or write access) to other resources on the network (e.g., other nodes, applications/services hosted by other nodes, data stored at other nodes, etc.). Typically, these attributes reflect facts about the node. Thus, while the attributes may change (e.g., the node may update its operating system and the operating system version attribute may also update accordingly), they still tend to reflect facts about the node’s current state. The access control service described below uses an additional attribute to indicate a node has access to a particular resource. When the attribute is taken away, the node will no longer have access to the resource. The attribute, therefore, enables JIT access to the resource without having to otherwise modify permissions given to the node or the node’s user.

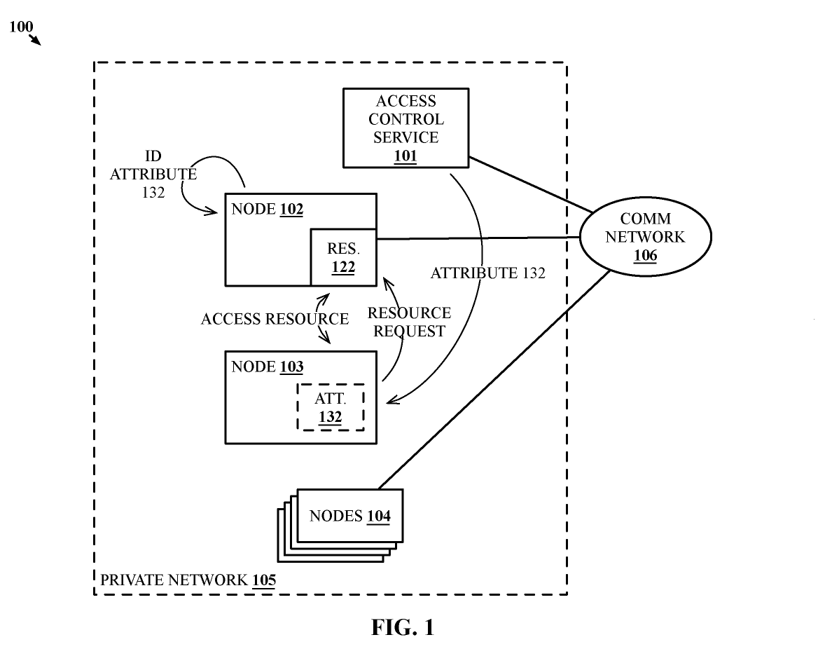

FIGS. 1 illustrates implementation 100 for controlling access of nodes to resources of a private network. Implementation 100 includes access control service 101, nodes 102-104, and communication network 106. Access control service 101 and nodes 102-104 communicate with each other over private network 105. Private network 105 is a private network, such as a Virtual Private Network (VPN) (or a physical private network in other examples), that uses an authentication mechanism, such as an identity provider, to ensure computing devices connected to private network 105 are authorized to join private network 105. Private network 105 is an overlay network on physical networking hardware, such wired/wireless communication links, routers, switches, firewalls, computing devices, or other type of components for providing network communications between computing systems. In some examples, at least a portion of the physical networking hardware is included in, or underlies a portion of, communication network 106. Communication network 106 may include one or more local area networks, wide area networks (e.g., the Internet), or some other type of network.

In operation, users of computing devices (e.g., personal computers, laptops, smartphones, tablets, servers, virtual machines, or other type of computing devices – including combinations thereof) authenticate themselves to private network 105 enabling the computing devices to connect to private network 105 as nodes 102-104 and exchange communications with each other over private network 105. Access control service 101 may be a dedicated computing system, or virtualized computing system, or may be a component of another computing system, such as a coordination service for private network 105. In some examples, access control service 101 may be implemented as a node on private network 105, included in one of nodes 102-104, or distributed across multiple of nodes 102-104. In other examples, access control service 101 may not be connected to private network 105. Rather, access control service 101 may communicate with nodes 102-104 using public addresses of the nodes over communication network 106. Private network 105 may leverage an external system, such as an Identity Provider (IdP), to authenticate users, may use an internal authentication mechanism, or may use some other mechanism for ensuring a computing device is associated with a user authorized to access private network 105. Devices of users that are unable to authenticate themselves to private network 105 (or are otherwise not allowed to access private network 105) are not allowed to join private network 105 as nodes to private network 105.

In cases where private network 105 is a VPN, an overlay network is achieved through a process called encapsulation, where the data packets sent between devices are wrapped inside additional packets that include encrypted information. For instance, when a VPN endpoint device (e.g., device of nodes 103-104) sends data through a VPN, a packet carrying the data is encrypted and then encapsulated with a new packet header that includes a public IP address of another VPN endpoint device as the destination. This encapsulated packet is then sent over a public network to the destination VPN endpoint device.

At the destination VPN endpoint device, the outer packet header is stripped away to reveal the original encrypted packet. The original packet is then decrypted, allowing the data to be processed by the device. In some examples, the VPN endpoint device may be a VPN server operating as a gateway to the public network. In those examples, the decrypted original packet may be transmitted to a destination IP address on the public network identified in a header of the original packet. The above encryption method ensures that the data remains confidential and secure as it travels over potentially insecure networks, as only the VPN destination endpoint can decrypt and access the original information. By creating a secure tunnel through encryption and encapsulation, VPNs effectively simulate a private network over a public infrastructure, providing privacy and security for users. As such, a communication received by a node over the VPN can be trusted to have been sent by another node authorized to access the VPN.

In some examples, nodes 102-104 may execute clients thereon to handle communications over private network 105. The clients may handle an authentication process for authenticating each of nodes 102-104 to connect to private network 105, encryption and encapsulation of packets for transmission over private network 105, decryption and decapsulation of packets received over private network 105, and may perform some other action for connecting to and communicating over private network 105.

Private network 105 uses attributes to determine which nodes have access to which resources on private network 105. A resource may be a node on private network 105, an application provided by a node(s), a service provided by a node(s), data stored at a node(s) (e.g., file, folder, table, etc.), or some other computing resource accessible over private network 105. A node may report its own attributes to private network 105 (e.g., to a coordination service of private network 105, access control service 101, or some other operating component of private network 105) or private network 105 may determine a node’s attributes using some other mechanism (e.g., user identity information from an IdP). For example, a node may provide an attribute indicating an operating system version executing thereon while private network 105 may determine an attribute indicating a location of the node from a public network address of the node.

The attributes are used as a basis for determining which resources a node can access over private network 105. In some examples, access control service 101 may supply rules to nodes on private network 105 defining which attributes enable a node to access (or not access) which resources. For instance, when a node requests access to a resource, another node hosting the resource may determine attributes of the requesting node. The rules are applied to the requesting node’s attributes to determine whether the requesting node should be allowed access. To enable JIT access to resources, access control service 101 also creates an attribute for a given resource with a corresponding rule indicating that a node having the attribute is allowed to access to the given resource (or possibly resources in some examples). Since this created attribute is assigned by access control service 101, it will not change unless access control service 101 makes the change (e.g., unlike an operating system version attribute which may change when the operating system updates). This enables access control service 101 to remove the node’s access to the given resource by removing the attribute. Advantageously, the JIT access to resources can be implemented by access control service 101 using existing attribute and rule infrastructure of private network 105.

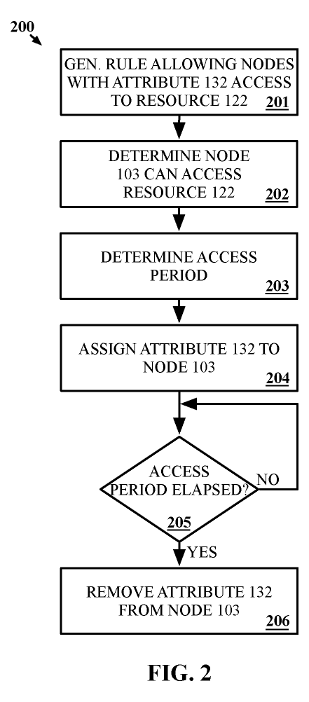

FIG. 2 illustrates operation 200 to control access of nodes to resources of a private network. Operation 200 is performed by access control service 101 to grant node 103 JIT access to resource 122 on node 102. Access control service 101 generates attribute 132, which will act as a flag indicating that any node with attribute 132 has access to resource 122 (step 201). As such, it is not necessary for attribute 132 to include any information other than information identifying itself as attribute 132. For instance, attributes for nodes may be key-value pairs. If the key for attribute 132 is listed in the attribute keys for a node, the value corresponding to the key is irrelevant because the key itself indicates attribute 132 is present. Access control service 101 further generates a rule defining that any node with attribute 132 is allowed access to resource 122.

Access control service 101 determines node 103 can access resource 122 (step 202). The determination may be based on information/instructions received from a user, may be automatically determined from other attributes of node 103, may be determined from information/instructions received from another node, or may be determined using some other mechanism. Access control service 101 further determines an access period for node 103 to access resource 122 (step 203). One benefit of JIT access is that the access can be taken away as easily as it can be given. There may be a default amount of time a node can have access to resource 122, access control service 101 may determine the amount of time based on other attributes of node 103 or a user thereof (e.g., a contractor may receive less time than an employee), or the time for the period may be determined from some other source. The period may be defined as an amount of time, an end time, an event occurrence, or some other trigger event indicating the access to resource 122 should be removed.

Access control service 101 assigns attribute 132 to node 103 in response to determining node 103 can access resource 122 (step 204). Access control service 101 may notify node 103 that node 103 now has attribute 132, may notify all of nodes 102-104 that node 103 has attribute 132, or may notify only node 103 and node 102 since those two nodes are the nodes for which attribute 132 has significance in this example. After assigning attribute 132 to node 103, node 103 can access resource 122 as described in operation 300.

Access control service 101 then waits for the determined period to elapse (step 205). For example, if the period is an amount of time, the amount of time may be measured from when access control service 101 assigned attribute 132 to node 103. Thus, access control service 101 may track the amount of time until the period is reached. Alternatively, if the period is defined by a triggering event, access control service 101 may monitor for when an event occurs triggering the removal of attribute 132. For example, the triggering event may be 5pm on the same day as access was granted and access control service 101 may wait for 5pm to be reached. Once the period has elapsed, attribute 132 removes from node 103 (step 206). Removal of attribute 132 may include notifying all nodes notified about node 103 having attribute 132 that node 103 no longer has attribute 132. As such, should node 103 attempt to access resource 122 after the removal, node 103 will be denied access due to not having attribute 132.

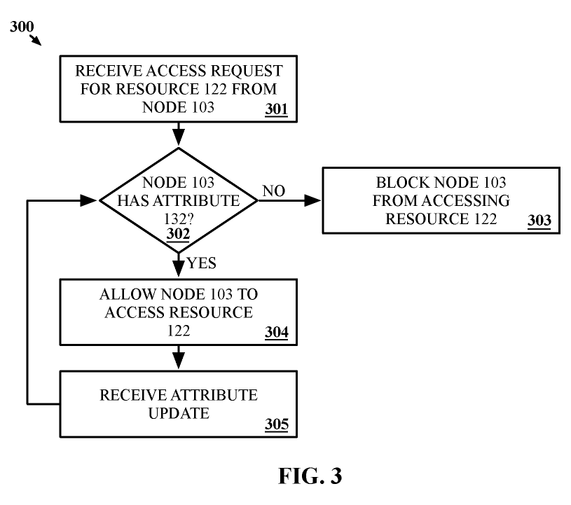

FIG. 3 illustrates operation 300 to control access of nodes to resources of a private network. Operation 300 is an example of how node 102 handles a received from node 103 to access resource 122 (step 301). The request may use any format or protocol necessitated by the type of resource being accessed (e.g., a request for an application may be formatted differently than a request for file access). To determine whether to allow the request, node 102 determines whether node 103 has attribute 132 (step 302). Node 102 may receive information having the attributes of node 103 from access control service 101. That information may be received after node 103 requests access to resource 122 (e.g., at the request of node 102) or access control service 101 may supply the information when node 103 connects to private network 105 (or when node 102 connects if after node 103). The information may then be updated when attributes change, such as when attribute 132 is assigned to node 103 by access control service 101. A rule provided by access control service 101 to node 102 that access to resource 122 should be allowed to any node having attribute 132. In this example, for simplicity, the only way node 103 will be allowed to access resource 122 is if node 103 has attribute 132. Thus, if node 103 does not have attribute 132, node 102 blocks node 103 from accessing resource 122 (step 303). For instance, node 102 may send a rejection in response to the request or may discard the request without replying. In other examples, node 102 may determine whether other attributes of node 103 satisfy other rules that allow node 103 to access resource 122.

Since node 103 has attribute 132 in this example, node 102 allows node 103 to access resource 122 (step 304). Allowing access to resource 122 may include responding to the request with information requested from resource 122, setting up an application layer connection to resource 122, or perform some other action to enable access to node 103 depending on the type of resource being accessed. That access is allowed to continue as long as node 103 has attribute 132. Thus, when node 102 receives an update to the attributes of node 103 (step 305). Node 102 again determines whether node 103 has attribute 132 (step 302). If attribute 132 is still present, then node 102 enables node 103 to continue accessing resource 122 (step 304). If attribute 132 has been removed (e.g., as occurs in step 206 of operation 200), then node 102 begins blocking node 103's access to resource 122 (step 303).

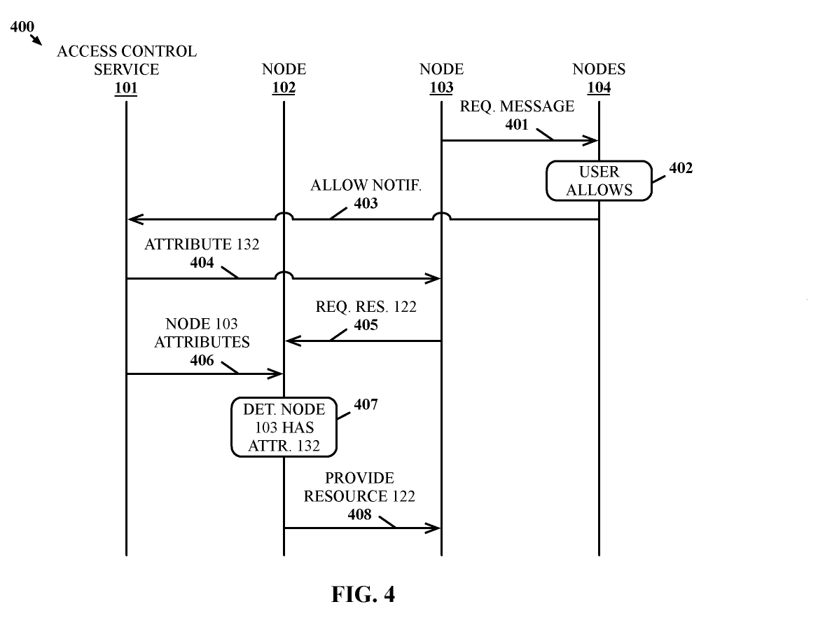

FIG. 4 illustrates operational scenario 400 for controlling access of nodes to resources of a private network. Operational scenario 400 is an example of how node 103 may request temporary access to resource 122 on node 102. A user of node 103 enters a message to a user of one of nodes 104 and sends the message to that node (step 401). The message may by any type of user communications that can be transmitted between devices for consumption by other users. For instance, a business operating private network 105 may maintain an internal instant messaging service allowing employees to communicate. The messages may be transmitted over private network 105 or may be transmitted over a public network (e.g., the Internet) enabling employees to communicate with other employees not necessarily connected to private network 105. The user of the node receiving the request message may read the message and determine whether the user of node 103 should be allowed to access resource 122. If the user of node 103 should not be allowed to access resource 122, the user of the receiving node need not do anything but may transmit a response message notifying the user of node 103 that they are not allowed to access resource 122.

If the user of node 103 should be allowed to access resource 122, the user of the node in nodes 104 takes action to indicate the allowance (step 402). In one example, the user may explicitly indicate through a user interface to access control service 101 that the user of node 103 is allowed to access resource 122 (step 403). Alternatively, the user may send a response message to the user of node 103 indicating that the user of node 103 is allowed to access resource 122. A bot may monitor the communications and recognize that the user of node 103 is allowed to access resource 122 from the response message. The bot may then notify access control service 101 of the fact that the user of node 103 should be allowed access to resource 122. In examples where the period in which node 103 will be allowed access is not predetermined, the user of the node in nodes 104 that received the request may indicate a period in their instruction. For instance, that user may send a response message saying, “yes, you can have access for two hours,” and the bot may notify access control service 101 that the access period should be set to two hours.

Upon being notified that node 103 should have access to resource 122, access control service 101 assigns attribute 132 to node 103 and begins tracking the period in which node 103 is to have access to resource 122 (step 404). In this example, access control service 101 informs node 103 that node 103 has attribute 132. Although, in some examples, it may not be necessary to notify node 103 about it having attribute 132 if node 103 will not be using attribute 132 (e.g., node 102 cares about node 103 having attribute 132 in this example but node 103 itself does not do anything with attribute 132). In other examples, access control service 101 may also notify others of nodes 102-104 that node 103 has attribute 132.

After attribute 132 has been assigned to node 103 but before elapsing of the period, node 103 requests access to resource 122 (step 405). Node 102 determines whether to allow the request based on attributes of node 103. Access control service 101 provides those attributes to node 102 (step 406). Node 102 may request node 103’s attributes from access control service 101 after receiving the access request or access control service 101 may provide the attributes at some other time. For example, node 102 may have been notified at step 404 that node 103 has attribute 132 so that information is ready should an access request be received from node 103. Any other attributes of node 103 may similarly be distributed to nodes 102-104 upon access control service 101 becoming aware of those attributes.

Node 102 applies rules to the attributes of node 103 to determine that node 103 has attribute 132 allowing node 103 to access resource 122 (step 407). Node 102 provides resource 122 to node 103 accordingly (step 408). While node 103's access is limited by the period, node 102 need not track whether the period has elapsed. Instead, node 102 can continue to provide resource 122 until otherwise notified node 103 no longer has attribute 132.

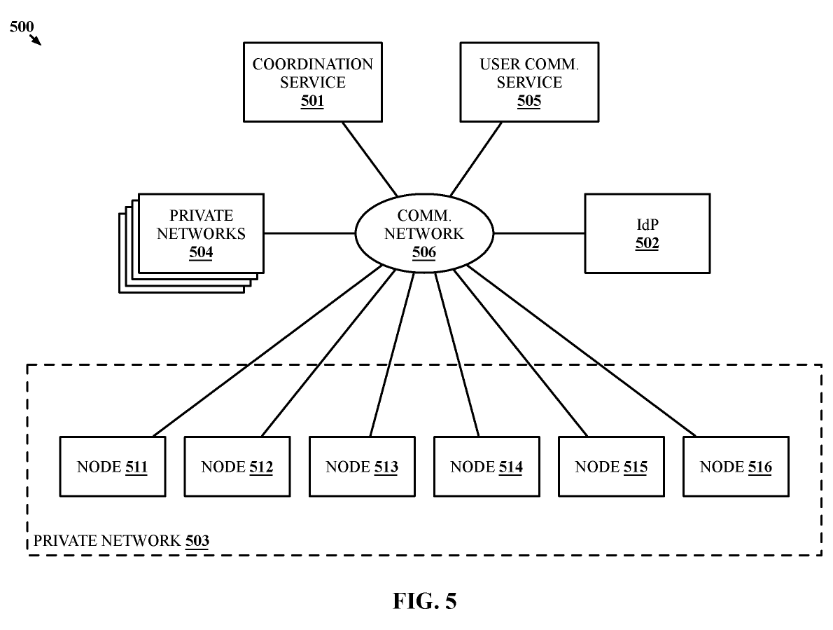

FIGS. 5 illustrates implementation 500 for controlling access of nodes to resources of a private network. Implementation 500 includes coordination service 501, identity provider 502, private network 503, private networks 504, communication network 506, and user communication service 505. Nodes 511-516 represent computing devices connected to private network 503. In this example, coordination service 501 operates as a control plane for private network 503 and, in some examples, for one or more additional private networks 504. Coordination service 501 may be implemented as a centralized computing system, a distributed set of coordination nodes, or a logical service executing across multiple physical systems. For example, coordination service 501 may be a cloud-based coordination platform, a collection of microservices deployed across data centers, or a component embedded within nodes 511-516 that cooperatively perform coordination functions. Coordination service 501 is configured to manage access to resources available on private network 503 by distributing access grants, determining attributes associated with nodes, and coordinating the assignment and removal of those attributes to control access to resources.

Private network 503 represents a logical network overlay connecting nodes 511-516, which may include computing systems such as servers, laptops, mobile devices, virtual machines, containers, or embedded systems. Private network 503 may be implemented using a Virtual Private Network, a software-defined networking overlay, or another secure communication infrastructure that enables nodes to communicate as though they are on a common network despite being connected through underlying public or private communication network 506. Communication network 506 may include one or more networks, such as the Internet, local area networks, wide area networks, or combinations thereof, and provides the underlying transport for communications between coordination service 501, identity provider 502, user communication service 505, and nodes 511-516.

Identity provider 502 is a system configured to authenticate users associated with nodes 511-516 and provide identity information usable by coordination service 501 to determine attributes of those nodes. Identity provider 502 may be an external authentication service, such as an enterprise identity platform, a cloud-based identity provider, or a directory service. In some examples, identity provider 502 maintains user attributes such as roles, group memberships, organizational affiliations, or permissions that coordination service 501 uses to determine factual attributes of nodes. These factual attributes may include attributes indicating a role of a user, a group associated with the user, or other characteristics derived from identity information. Coordination service 501 may coordinate with identity provider 502 during node onboarding, during periodic reauthentication, or in response to changes in user identity information to ensure that attributes associated with nodes remain up to date.

Coordination service 501 is further configured to distribute access grants to nodes 511-516 on private network 503. The access grants define which attributes, when assigned to a node, enable access to particular resources available on private network 503. A resource, in this context, may include another node, a service provided by a node, an application programming interface, a data store, or any other network-accessible functionality. In some examples, coordination service 501 distributes access grants to nodes 511-516 when those nodes initially join private network 503 and may update the access grants over time to reflect changes in policy, resource availability, or administrative configuration. Nodes receiving the access grants may locally evaluate the access grants in combination with attributes associated with requesting nodes to determine whether to allow or deny access to resources.

User communication service 505 represents a communication platform through which users of nodes 511-516 may exchange messages. User communication service 505 may include, for example, messaging platforms, collaboration tools, email systems, ticketing systems, or other communication interfaces that allow users to request and grant access to resources. In some implementations, user communication service 505 may host or execute software agents, such as bots, that monitor communications between users to identify access requests and corresponding approvals. While user communication service 505 is shown as a separate system, in some examples it may be integrated into coordination service 501, implemented within nodes 511-516, or provided by a third-party service accessible over communication network 506.

Private networks 504 represent one or more additional private networks that may be coordinated by coordination service 501. In some examples, nodes associated with private network 503 may also be associated with one or more of private networks 504, and coordination service 501 may manage access across those networks using similar mechanisms for distributing access grants and assigning attributes. For instance, coordination service 501 may enforce policies that allow a node to access resources across multiple private networks based on attributes derived from identity provider 502 or other sources. In other examples, private networks 504 may be isolated from private network 503, with coordination service 501 maintaining separate access grants and attribute sets for each network.

In operation, coordination service 501 establishes a framework in which nodes 511-516 rely on attributes assigned to nodes and access grants distributed to nodes to determine whether access to resources is allowed. Attributes associated with a node may include factual attributes derived from identity provider 502 or from the system implementing the node, as well as control attributes assigned to provide time-limited or event-limited access to resources. Access grants distributed by coordination service 501 define mappings between attributes and resources such that nodes can evaluate access decisions locally without requiring continuous interaction with coordination service 501. This distributed evaluation enables nodes to determine access permissions based on current attributes of requesting nodes while coordination service 501 manages the lifecycle of those attributes, including assignment and removal in accordance with defined criteria.

In some examples, coordination service 501 does not rely on nodes 511-516 to evaluate access grants directly using attributes. Instead, coordination service 501 may receive high-level policy definitions, node attributes, and identity information, and compute corresponding enforcement rules for nodes 511-516. The enforcement rules may be packet-handling rules or filtering rules that define whether communications between nodes are permitted, such as rules indicating that traffic from a network address associated with node 511 is allowed to access a network address associated with node 516 over a specified protocol or port. Coordination service 501 may then distribute the enforcement rules to nodes 511-516, which enforce the rules when handling communications without independently interpreting the underlying attributes or grants. In such examples, nodes 511-516 may be unaware of specific attributes or policies that caused a rule to be generated and may instead apply the rules as provided.

In further examples, coordination service 501 may use a hybrid approach in which some access decisions are enforced using distributed attributes and access grants, while other decisions are compiled into enforcement rules and distributed to nodes. For example, coordination service 501 may distribute attributes and grants for certain resources while generating rule-based controls for other resources, or may dynamically select between approaches based on resource type, policy complexity, or performance considerations. In yet other examples, nodes 511-516 may locally evaluate attributes for some access decisions and may also receive rule updates from coordination service 501 for other access decisions. This flexibility allows coordination service 501 to centralize policy logic while still enabling distributed enforcement across private network 503.

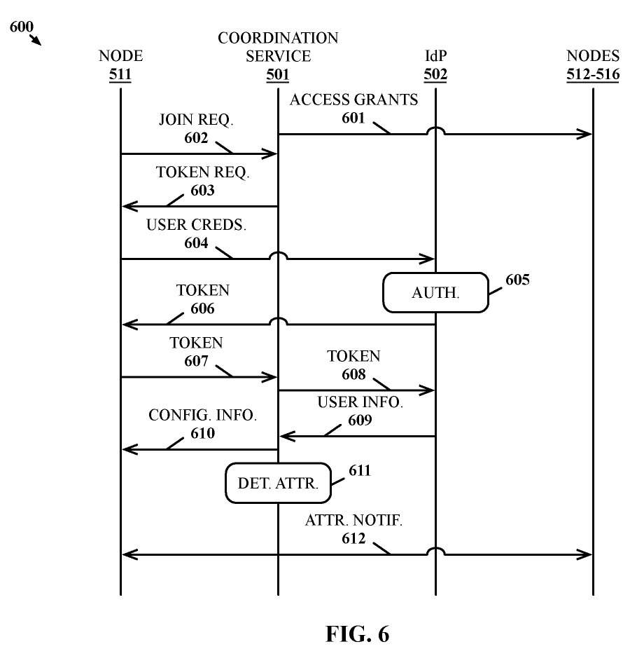

FIG. 6 illustrates operational scenario 600 for controlling access of nodes to resources of a private network. In operational scenario 600, coordination service 501 distributes access grants to nodes 512-516 (step 601). The access grants define, for nodes on private network 503, which attributes enable access to which resources. Each access grant may correspond to a rule that maps one or more attributes to a particular resource or set of resources. For example, an access grant may indicate that nodes having a particular role attribute and an operating system version attribute are permitted to access a database service, while another access grant may indicate that nodes having a different attribute are permitted to access an application programming interface. Coordination service 501 may distribute the access grants when nodes 512-516 initially join private network 503 and may update the access grants over time to reflect changes in policy, resource configurations, or administrative input. In some examples, coordination service 501 transmits the full set of access grants to each node, while in other examples, coordination service 501 may transmit a subset of access grants relevant to particular nodes or resources.

Node 511 is not yet joined to private network 503 in this example. Node 511 sends, to a public network address of coordination service 501, a request to join private network 503 (step 602). The request may include identifying information for node 511, such as a device identifier, a public key, a network address, or other information usable by coordination service 501 to establish communication with node 511. Coordination service 501 responds to the request from node 511 with a request for a token indicating identity provider 502 has authenticated the user of node 511 (step 603). The token request may specify requirements for authentication, such as multi-factor authentication, validation of device posture, or confirmation of user credentials.

Node 511 requests the token by sending credentials of the user to identity provider 502 (step 604). The credentials may include a username and password combination, a certificate, a biometric input, or another authentication factor. Identity provider 502 authenticates the user credentials (step 605) and, upon successful authentication, sends, to node 511, a token corresponding to the authentication of the user credentials (step 606). The token may include information identifying the authenticated user, such as a user identifier, roles, group memberships, or other attributes, and may be cryptographically signed or otherwise secured to prevent tampering. Node 511 passes the received token to coordination service 501 in response to the request for the token from coordination service 501 (step 607).

In this example, coordination service 501 uses the token to request information about the user stored at identity provider 502 (step 608). The request may include the token itself, or information derived from the token, and may request user attributes associated with the authenticated user. Coordination service 501 receives the requested information from identity provider 502 (step 609) and uses the user information to determine network configuration information for node 511 to communicate with nodes 512-516 over private network 503 (step 610). The network configuration information may include a private network address assigned to node 511, public endpoint information for establishing communications, cryptographic material for secure communications, and the access grants that were already provided to nodes 512-516. In some examples, coordination service 501 may also transmit configuration updates to nodes 512-516 to enable those nodes to recognize node 511 as a participant in private network 503.

Coordination service 501 also determines attributes to assign to node 511 from the user information (step 611). The attributes determined at this stage may include factual attributes derived from identity provider 502, such as role attributes, group attributes, or other user-related information. Coordination service 501 may also use information about the computing system implementing node 511, such as a hardware type, operating system version, compliance posture, or geographic location, to determine additional attributes. The resulting attributes represent characteristics of node 511 that nodes 512-516 can evaluate against access grants to determine whether node 511 is permitted to access various resources.

Coordination service 501 notifies nodes 511-516 that node 511 has been assigned the determined attributes (step 612). The notification may include a full set of attributes for node 511 or may include incremental updates identifying newly assigned attributes. In some examples, coordination service 501 provides the attributes to node 511 with the configuration information at step 610, while in other examples the attributes are distributed through separate messages. Notifying nodes 512-516 enables those nodes to locally evaluate access requests from node 511 using the access grants previously distributed. In addition, notifying node 511 about its own attributes may enable node 511 to perform local checks prior to attempting to access resources, such as determining that a request would be denied based on the current attributes. This approach allows access decisions to be evaluated at nodes receiving access requests while coordination service 501 manages the distribution and lifecycle of attributes associated with node 511.

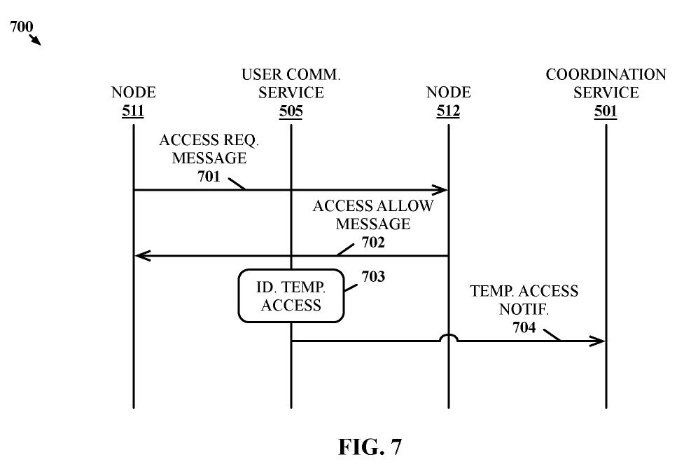

FIG. 7 illustrates operational scenario 700 for controlling access of nodes to resources of a private network. Operational scenario 700 is a continuation of operational scenario 600 and involves interactions between node 511, node 512, coordination service 501, and user communication service 505. In this example, a user of node 511 exchanges user communications with a user associated with node 512 over a communication channel. The communication channel may be implemented through user communication service 505, which may include messaging platforms, collaboration systems, ticketing tools, or other communication interfaces capable of transmitting messages between users. Although the communication channel is illustrated as passing through user communication service 505, the communication channel may alternatively be implemented using peer-to-peer messaging, email systems, or communication systems external to private network 503. In some examples, the user of node 512 having authority to grant access may be operating a computing device that is not itself a node on private network 503, but is still able to participate in the communication channel through user communication service 505.

In operational scenario 700, the user of node 511 sends a message requesting access to a resource not enabled by the access grants distributed in operational scenario 600 (step 701). The message may specify the resource explicitly, such as referencing a particular application, service, dataset, or node, or may describe the requested access in natural language. For example, the message may state a need to access a production database, a restricted API endpoint, or a file repository. The format of the request is not constrained to a predefined structure and may be expressed using free-form natural language, structured input forms, or combinations thereof. The user communication service 505 transmits the request message to the user associated with node 512, who in this example has authority to approve access to the requested resource based on organizational roles, administrative privileges, or predefined policy delegations.

The user of node 512 responds to the request message with a message indicating that the requested access is allowed (step 702). The response message may include additional information, such as a duration for which the access should be granted, a condition under which the access should be revoked, or a justification for granting the access. For instance, the response may specify that access is granted for a defined period such as one hour, until completion of a task, or until occurrence of an event such as user logout or system maintenance completion. In some examples, the exchange of messages between the users of node 511 and node 512 may include additional communications beyond the initial request and approval, such as follow-up questions, clarifications, or confirmations regarding the scope or duration of access.

In this example, a bot or other software agent executes in user communication service 505 on behalf of coordination service 501. The bot is configured to monitor communications exchanged over the communication channel and to identify requests for access to resources and corresponding approval responses (step 703). Monitoring may include analyzing message content using natural language processing techniques, keyword detection, pattern recognition, or structured message parsing to determine whether a request has been made and whether the request has been granted by an authoritative user. The bot may be configured to monitor communications associated with specific users, such as users with authority to grant access, or communications occurring within designated channels, groups, or conversation threads of user communication service 505. In other examples, the functionality of the bot may be implemented at endpoints, such as within node 511 or node 512, or within coordination service 501.

Upon identifying a message exchange in which access to the requested resource is granted to the user of node 511, the bot generates a notification and sends the notification to coordination service 501 (step 704). The notification indicates that node 511 is allowed to access the requested resource and may include additional information extracted from the message exchange. In some examples, the bot determines that the user of node 511 made a request for access using natural language and that the user associated with node 512 provided a corresponding natural language response granting the request. The notification may further indicate a defined period for the access, where the defined period may correspond to a duration, expiration time, or event condition expressed in the response message. The notification may also include identifiers for the requesting node, the resource, and the approving user, which coordination service 501 may use to determine an appropriate control attribute to assign to node 511. In some examples, the bot validates that the approving user has authority to grant the access before generating the notification, while in other examples coordination service 501 performs such validation upon receiving the notification.

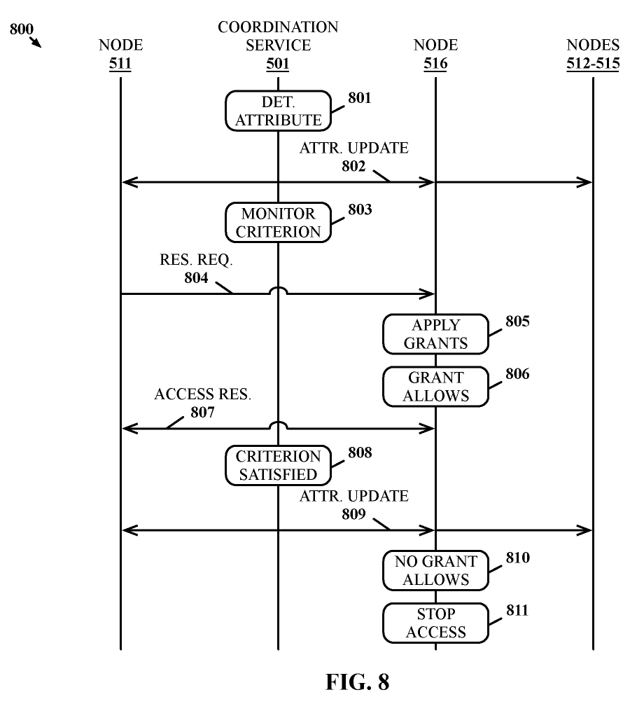

FIG. 8 illustrates operational scenario 800 for controlling access of nodes to resources of a private network. Operational scenario 800 is a continuation of operational scenario 700 after coordination service 501 receives a notification indicating that access to a resource has been approved for node 511. In this example, coordination service 501 determines an attribute that, when assigned to node 511, will provide access to the requested resource (step 801). The attribute may be a control attribute that signifies authorization to access the resource independent of other factual attributes associated with node 511. For example, the attribute may be represented as a key within a set of node attributes, where the presence of the key alone indicates that node 511 is permitted to access the resource. In some examples, coordination service 501 identifies an existing attribute that corresponds to the requested resource, while in other examples coordination service 501 generates a new attribute and may also generate a corresponding access grant that maps the attribute to the resource. When creating a new attribute, coordination service 501 may ensure the attribute conforms to naming conventions, attribute namespaces, or uniqueness constraints maintained across private network 503.

Coordination service 501 notifies nodes 511-516 that the attributes of node 511 have been updated to include the determined attribute (step 802). The notification may include an updated attribute set for node 511 or may include a delta update specifying the addition of the control attribute. Nodes 511-516 may store the attributes locally, cache the attributes for subsequent access decisions, or apply the update immediately to ongoing access evaluations. In some implementations, coordination service 501 selectively notifies only a subset of nodes associated with the resource, such as node 516, while in other implementations coordination service 501 notifies all nodes on private network 503 to maintain a consistent view of attributes. This distribution of attribute information enables nodes to independently determine whether access should be permitted without querying coordination service 501 for each access attempt.

Coordination service 501 then begins monitoring one or more criteria associated with the temporary access granted to node 511 (step 803). The one or more criteria define a period during which the access is permitted and may include a time-based condition, an event-based condition, or combinations thereof. In a time-based example, coordination service 501 determines whether a defined duration has elapsed since assignment of the control attribute or whether a specified expiration time has been reached. In an event-based example, coordination service 501 identifies occurrence of an event, such as completion of a task, termination of a session, logout of the user, or receipt of a revocation signal, to determine that the defined period has been reached. In some examples, the criteria correspond to access criterion 1022 extracted from user communications and may be explicitly provided in the approval message or inferred therefrom. Coordination service 501 may implement monitoring by maintaining timers, subscribing to event streams, polling external systems, or evaluating conditions derived from user communication service 505 or identity provider 502. By centralizing monitoring within coordination service 501, nodes 511-516 are not required to independently track whether the defined period has been reached.

In this example, node 516 is a node that provides the requested resource. Node 516 may host the resource directly or may act as a gateway or intermediary to the resource, such as an application server, database server, file system, or service endpoint. Node 511 sends a request to access the resource from node 516 (step 804). The request may be formatted according to an application-specific protocol, such as an HTTP request, a database query, a file access request, or another type of service-specific interaction. Node 516 receives the request and applies the access grants to the attributes of node 511 (step 805). This evaluation may involve comparing the attributes associated with node 511 against a set of access grants stored locally at node 516, where each access grant defines a mapping between attributes and permitted resources.

Based on applying the access grants, node 516 determines that node 511 has an attribute allowing node 511 to access the resource according to at least one access grant (step 806). In particular, the presence of the control attribute assigned at step 801 may satisfy an access grant that enables access to the resource regardless of other factual attributes associated with node 511. As a result, node 516 provides access to the resource to node 511 (step 807). Providing access may include transmitting requested data, establishing a session, executing a requested operation, or enabling continued interaction with the resource.

At a later time, coordination service 501 determines that a criterion for removing node 511’s access has been satisfied (step 808). For example, coordination service 501 may determine that a defined period has elapsed, that an event occurrence has taken place, or that another condition specified in the notification from operational scenario 700 has been met. In response, coordination service 501 notifies nodes 511-516 that the attributes of node 511 have been updated to remove the control attribute that granted access to the resource (step 809). This notification updates the attribute state maintained at nodes 511-516 such that subsequent access evaluations reflect the removal of the control attribute.

Should node 511 attempt to continue accessing the resource after removal of the control attribute, node 516 applies the access grants to the updated attributes of node 511 (step 810). Without the control attribute, node 511 may no longer satisfy any access grant that permits access to the resource. As a result, node 516 determines that access should be denied and stops allowing node 511 to access the resource (step 811). Stopping access may include terminating an ongoing session, denying new requests, revoking issued tokens, or otherwise preventing node 511 from interacting with the resource. This sequence demonstrates how coordination service 501 manages the lifecycle of the control attribute to grant and revoke access based on defined criteria while nodes enforce access decisions using locally applied access grants and attribute information.

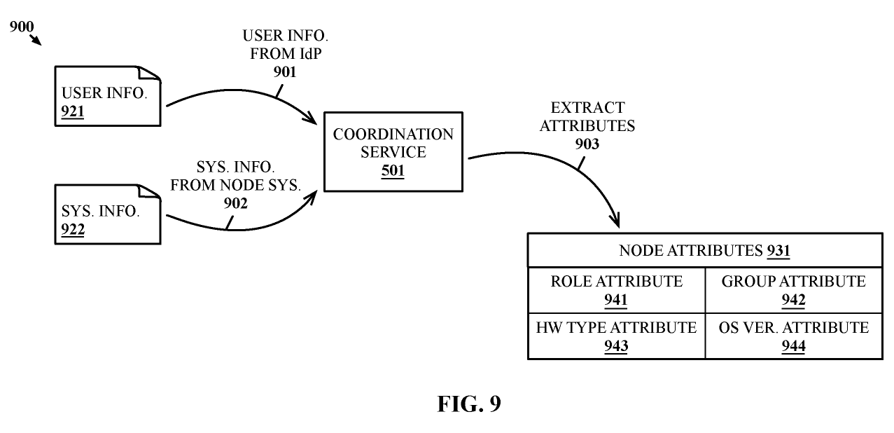

FIG. 9 illustrates operational scenario 900 for controlling access of nodes to resources of a private network. Operational scenario 900 is an example of how coordination service 501 may determine factual attributes for node 511. In this example, factual attributes are attributes that represent characteristics of a user or a computing system implementing a node and are not assigned for the purpose of granting temporary access to a resource. Rather, factual attributes reflect baseline conditions that are used in evaluating access grants for resources on private network 503. Coordination service 501 receives user information 921 about the user of node 511 from identity provider 502 (step 901) and receives system information 922 about the system on which node 511 is implemented from node 511 (step 902). User information 921 may include identity-related data such as user identifiers, role assignments, organizational group memberships, department affiliations, or security classifications. System information 922 may include data describing the computing system implementing node 511, such as hardware characteristics, operating system details, software versions, device posture information, or security compliance indicators. In some examples, system information 922 may be collected directly from node 511 during onboarding or through periodic reporting, while in other examples system information 922 may be derived from monitoring systems, endpoint management tools, or external data sources.

Coordination service 501 identifies components of user information 921 and system information 922 that correspond to attributes available for assignment to node 511 and extracts node attributes 931 (step 903). This extraction process may involve mapping values from user information 921 and system information 922 to predefined attribute schemas, converting raw data into normalized attribute formats, or selecting specific data elements based on policy definitions. For example, coordination service 501 may evaluate user roles within user information 921 and select a role attribute corresponding to a job function, evaluate group memberships to select a group attribute corresponding to an organizational unit, or evaluate device properties within system information 922 to select attributes corresponding to hardware type or operating system version. Coordination service 501 may further filter, combine, or transform data values to create attributes that are consistent across nodes on private network 503. In some examples, coordination service 501 may maintain a catalog of attribute types and use that catalog to determine which data elements from user information 921 and system information 922 should be included in node attributes 931.

In this example, node attributes 931 include role attribute 941, group attribute 942, hardware-type attribute 943, and operating system version attribute 944. Role attribute 941 corresponds to a role assigned to the user of node 511, such as an administrative role, a developer role, or a support role. Group attribute 942 corresponds to a workgroup or organizational unit associated with the user, such as an engineering group, a legal department, or a finance team. Hardware-type attribute 943 indicates a type of computing system implementing node 511, such as a laptop, a server, a virtual machine, or a mobile device. Operating system version attribute 944 indicates a version of an operating system executing on the computing system, such as a particular release of a Linux distribution, a specific version of a Windows operating system, or a mobile operating system version. These attributes are illustrative examples, and node attributes 931 may include additional or alternative attributes in other examples, such as geographic location attributes, network connectivity attributes, device posture attributes, encryption capability attributes, or software application attributes.

Node attributes 931 are used by nodes 512-516 when applying access grants to determine whether node 511 is permitted to access resources on private network 503. Because factual attributes represent characteristics that are generally stable or derived from authoritative sources such as identity provider 502 or the computing system of node 511, they provide a baseline for access control decisions. Coordination service 501 may update node attributes 931 when user information 921 changes, such as when a user’s role or group membership is modified, or when system information 922 changes, such as when a device is updated or reconfigured. In this manner, node attributes 931 reflect current conditions of the user and device associated with node 511 and serve as inputs to the evaluation of access grants distributed by coordination service 501.

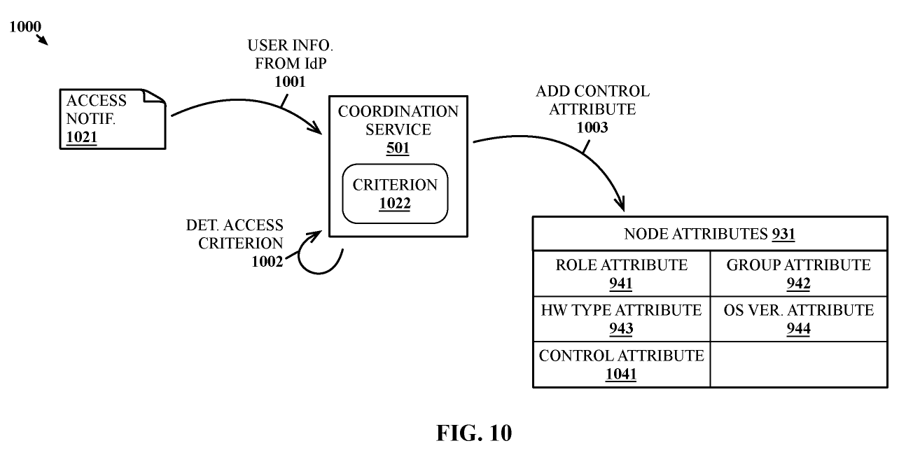

FIG. 10 illustrates operational scenario 1000 for controlling access of nodes to resources of a private network. Operational scenario 1000 provides additional detail regarding how coordination service 501 incorporates temporary-access information into node attributes. In operational scenario 1000, coordination service 501 receives access notification message 1021 (step 1001). Access notification message 1021 may be generated by user communication service 505, a bot executing therein, or another system that monitors user interactions, and indicates that the user of node 511 has been granted access to resource 1121. In addition to identifying the granted access, access notification message 1021 may include one or more parameters describing the conditions of the access, such as the approving user, the resource identifier, and a temporary-access criterion that defines the period during which access should be allowed. In some examples, access notification message 1021 may be formatted as a structured message including fields for each parameter, while in other examples the message may include unstructured data that coordination service 501 parses to extract relevant information.

Coordination service 501 determines access criterion 1022 from access notification message 1021 (step 1002). Access criterion 1022 represents a condition that, when satisfied, indicates that the access granted to node 511 should be removed. The criterion may take various forms depending on the context of the access. For example, access criterion 1022 may specify a time-based condition such as a duration from the time of assignment, an absolute expiration timestamp, or an interval during which access is permitted. In other examples, access criterion 1022 may specify an event-based condition, such as completion of a task, a user logging out, a system state change, or receipt of a revocation signal from another system. In further examples, access criterion 1022 may include combinations of multiple conditions, such as a time limit combined with an event trigger, where satisfaction of any of the conditions results in removal of access. Coordination service 501 may store access criterion 1022 in association with node 511 and resource 1121 and may implement monitoring mechanisms, as described in operational scenario 800, to determine when the criterion has been satisfied.

After determining access criterion 1022, coordination service 501 adds control attribute 1041 to node attributes 931 (step 1003). Control attribute 1041 is distinct from factual attributes derived from user information 921 and system information 922 in that control attribute 1041 does not describe a property of the user or the computing system implementing node 511. Instead, control attribute 1041 functions as an indicator that node 511 is authorized to access resource 1121 in accordance with the access approval reflected in access notification message 1021. In some examples, control attribute 1041 may be represented as a key within node attributes 931, where the presence of the key indicates authorization, and any associated value is not required for evaluation. In other examples, control attribute 1041 may include a value that encodes information such as the resource identifier, a scope of access, or a reference to access criterion 1022.

Control attribute 1041 may be associated with a corresponding access grant that defines that nodes having control attribute 1041 are allowed to access resource 1121. In some cases, coordination service 501 may have previously distributed such an access grant as part of a plurality of access grants distributed in operational scenario 600, each of the access grants defining attributes enabling access to respective resources on private network 503. In other cases, coordination service 501 may create a new access grant (or modify an existing grant) corresponding to control attribute 1041 and distribute the new access grant to nodes on private network 503, including at least node 516 associated with resource 1121. The association between control attribute 1041 and resource 1121 enables nodes, such as node 516, to permit access when evaluating access requests from node 511 without requiring awareness of the underlying approval process that triggered the assignment of control attribute 1041. Coordination service 501 may notify nodes associated with resource 1121 that control attribute 1041 has been assigned to node 511 such that those nodes can determine that node 511 is allowed access upon receiving subsequent requests.

In some examples, the user of node 511 may be associated with multiple nodes on private network 503, such as a laptop, a virtual machine, and a mobile device. Coordination service 501 may determine that control attribute 1041 should be applied to one or more of those nodes to provide access across multiple computing systems associated with the same user. In such examples, coordination service 501 may identify the additional nodes based on user identity information obtained from identity provider 502 and update attributes for those nodes accordingly. In other examples, control attribute 1041 may be restricted to a single node, such as node 511, based on policy or conditions specified in access notification message 1021.

Through the addition of control attribute 1041 to node attributes 931, coordination service 501 integrates temporary-access decisions into the attribute-based access control model implemented across private network 503. Nodes that receive updated attribute information can evaluate access requests using existing access grants without requiring explicit knowledge of the temporary-access logic or the communication events that led to the assignment of control attribute 1041. Coordination service 501 maintains responsibility for managing the lifecycle of control attribute 1041 in accordance with access criterion 1022, including eventual removal of the attribute once the defined condition has been satisfied.

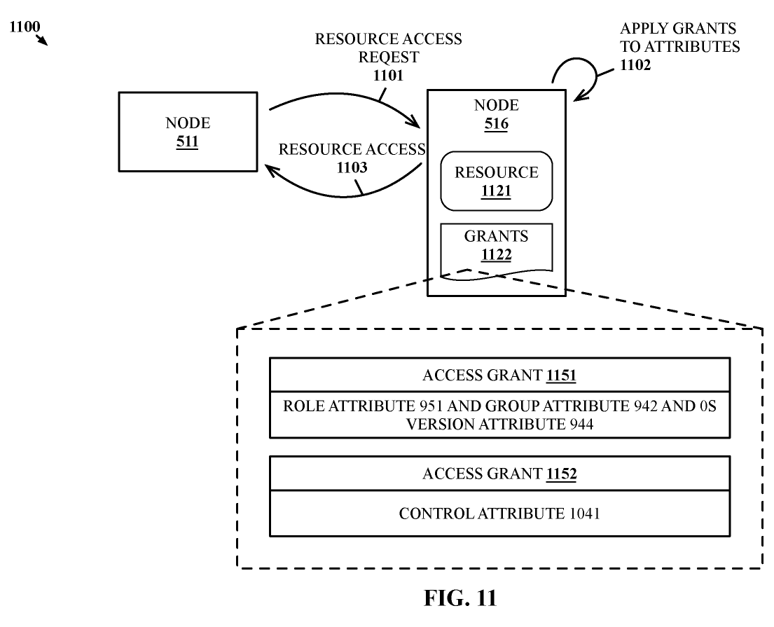

FIG. 11 illustrates operational scenario 1100 for controlling access of nodes to resources of a private network. Operational scenario 1100 provides an example of how node 516 evaluates an access request using access grants 1122 and node attributes 931. In operational scenario 1100, node 516 includes resource 1121 and receives a request to access resource 1121 from node 511 (step 1101). Resource 1121 may be any type of resource accessible over private network 503, such as a database service, an application endpoint, a file system location, a compute workload, or another node providing functionality. The request transmitted from node 511 may be formatted according to a protocol associated with resource 1121, such as an HTTP request for a web service, a query for a database, a remote procedure call, or a file access operation. Node 516 may be a host system for resource 1121, a gateway providing controlled access to resource 1121, or an intermediary service that enforces access decisions prior to forwarding requests to resource 1121.

Upon receiving the request, node 516 applies access grants 1122 to node attributes 931 associated with node 511 to determine whether access should be allowed (step 1102). Node attributes 931 may have been previously received from coordination service 501, cached locally at node 516, or retrieved in response to the request. For example, node 516 may maintain a local data structure mapping node identifiers, such as network addresses or public keys, to corresponding attribute sets. In other examples, node 516 may query coordination service 501 or another attribute service to obtain the current attributes of node 511. Access grants 1122 represent a set of rules distributed by coordination service 501 that define which attributes enable access to which resources. Access grants 1122 may be stored locally at node 516 and may be updated periodically as coordination service 501 distributes changes to access control policies.

In this example, access grants 1122 include access grant 1151 and access grant 1152. Access grant 1151 defines that nodes having a specified combination of attributes, such as role attribute 951, group attribute 942, and operating system version attribute 944, are allowed to access resource 1121. This type of access grant represents a rule based on factual attributes of a node, and access is allowed only when the node attributes satisfy the specified conditions. Access grant 1152 defines that nodes having control attribute 1041 are allowed to access resource 1121. This access grant represents a rule that enables access based on the presence of a control attribute, independent of other factual attributes. In practice, access grants may include a wide range of conditions, such as requiring multiple attributes, allowing alternative attribute combinations, or specifying additional constraints based on context or policy.

Node 516 evaluates node attributes 931 of node 511 against access grants 1122 to determine whether the request should be allowed. In this example, node attributes 931 include role attribute 941, group attribute 942, hardware-type attribute 943, and operating system version attribute 944, as well as control attribute 1041 that was assigned in operational scenario 1000. Although role attribute 941 does not match role attribute 951 required by access grant 1151, and thus node 511 does not satisfy access grant 1151, the presence of control attribute 1041 in node attributes 931 satisfies access grant 1152. As a result, node 516 determines that node 511 is allowed to access resource 1121 based on access grant 1152. This demonstrates how control attribute 1041 can override or supplement access decisions that would otherwise be determined solely based on factual attributes.

In response to determining that access should be allowed, node 516 provides access to resource 1121 to node 511 (step 1103). Providing access may include returning requested data, executing a requested operation, establishing a session with resource 1121, or enabling continued interaction with the resource. In some examples, node 516 may maintain an active session with node 511 for ongoing access, while in other examples each request may be evaluated independently based on current node attributes 931 and access grants 1122. Node 516 may also log the access event, apply rate limits, or enforce additional controls as part of providing access to resource 1121.

At a later point, as described in prior operational scenarios, coordination service 501 removes control attribute 1041 from node attributes 931 upon satisfaction of access criterion 1022. Coordination service 501 may notify node 516 and other nodes on private network 503 that attributes of node 511 no longer include control attribute 1041. When node 511 subsequently attempts to access resource 1121, node 516 applies access grants 1122 to node attributes 931 as updated. Because node attributes 931 no longer include control attribute 1041, node 511 no longer satisfies access grant 1152 and may also fail to satisfy access grant 1151. Node 516 therefore determines that attributes of node 511 do not allow access to resource 1121 and blocks access accordingly. Blocking access may include denying a new request, terminating an existing session, or otherwise stopping node 511 from accessing resource 1121 in response to determining that control attribute 1041 has been removed.

Operational scenario 1100 illustrates how node-based evaluation of access requests enables enforcement of access control policies using distributed access grants and attribute information. Coordination service 501 manages the distribution of access grants 1122 and the assignment and removal of attributes, including control attribute 1041, while node 516 enforces access decisions locally by applying access grants 1122 to node attributes 931. This separation allows access control decisions to be performed efficiently at nodes hosting resources while maintaining centralized coordination over policy and attribute lifecycle.

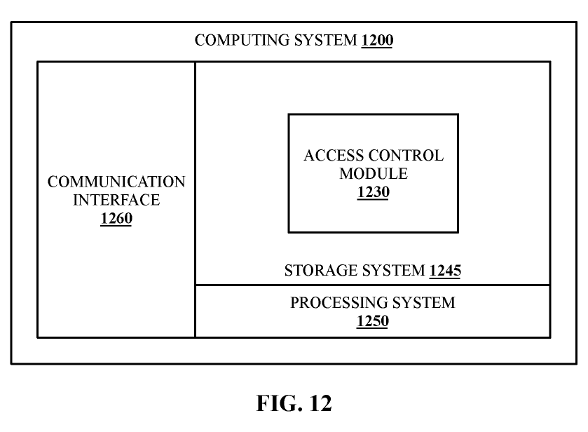

FIG. 12 illustrates computing system 1200 for controlling access of nodes to resources of a private network. Computing system 1200 is representative of any computing system or systems with which the various operational architectures, processes, scenarios, and sequences disclosed herein can be implemented. Computing system 1200 is an example architecture for access control service 101, nodes 102-104, coordination service 501, identity provider 502, user communication service 505, and nodes 511-516, although other examples may exist. Computing system 1200 includes storage system 1245, processing system 1250, and communication interface 1260. Processing system 1250 is operatively linked to communication interface 1260 and storage system 1245. Communication interface 1260 may be communicatively linked to storage system 1245 in some implementations. Computing system 1200 may further include other components such as a battery and enclosure that are not shown for clarity.

Communication interface 1260 comprises components that communicate over communication links, such as network cards, ports, radio frequency (RF), processing circuitry and software, or some other communication devices. Communication interface 1260 may be configured to communicate over metallic, wireless, or optical links. Communication interface 1260 may be configured to use Time Division Multiplex (TDM), Internet Protocol (IP), Ethernet, optical networking, wireless protocols, communication signaling, or some other communication format – including combinations thereof. Communication interface 1260 may be configured to communicate with other computing systems via one or more networks.

Processing system 1250 comprises microprocessor and other circuitry that retrieves and executes operating software from storage system 1245. Storage system 1245 may include volatile and nonvolatile, removable, and non-removable media implemented in any method or technology for storage of information, such as computer readable instructions, data structures, program modules, or other data. Storage system 1245 may be implemented as a single storage device but may also be implemented across multiple storage devices or sub-systems. Storage system 1245 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no interpretations would storage media of storage system 1245, or any other computer-readable storage medium herein, be considered a transitory form of signal transmission (often referred to as "signals per se"), such as a propagating electrical or electromagnetic signal or carrier wave.

Processing system 1250 is typically mounted on a circuit board that may also hold storage system 1245. The operating software of storage system 1245 comprises computer programs, firmware, or some other form of machine-readable program instructions. The operating software of storage system 1245 comprises access control module 1230. The operating software on storage system 1245 may further include an operating system, utilities, drivers, network interfaces, applications, or some other type of software. When read and executed by processing system 1250 the operating software on storage system 1245 directs computing system 1200 to control access of nodes to resources of a private network as described herein. Access control module 1230 may execute natively on processing system 1250 or the operating software may include virtualization software, such as a hypervisor, to virtualize computing hardware on which access control module 1230 executes. Access control module 1230 may be a component of a coordination service coordinating nodes on the private network.

In at least one example, access control module 1230 executes on processing system 1250 and directs processing system 1250 to determine an attribute signifying an associated node has access to a resource on the private network. In response to determining a node on the private network is allowed to access the resource for a defined period, access control module 1230 directs processing system 1250 to assign the attribute to the node. Upon reaching the defined period after assigning the attribute to the node, access control module 1230 directs processing system 1250 to remove the attribute from the node.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method for granting access to resources on a private network, the method comprising:
in an access control service for the private network:
determining an attribute signifying an associated node has access to a resource on the private network;
in response to determining a node on the private network is allowed to access the resource for a defined period, assigning the attribute to the node; and
upon reaching the defined period after assigning the attribute to the node, removing the attribute from the node.

2. The method of claim 1, wherein the defined period is an amount of time and the method comprising:
determining the amount of time has elapsed since assigning the attribute to the node to determine the defined period has been reached.

3. The method of claim 1, wherein the defined period is an event occurrence and the method comprising:
identifying the event occurrence to determine the defined period has been reached.

4. The method of claim 1, comprising:
determining, from user communications exchanged with an authoritative user, the node is allowed to access the resource.

5. The method of claim 4, wherein determining the node is allowed to access the resource comprises:
using a bot attached to a communication channel carrying the user communications, monitoring user communications for a request from a user of the node to receive access to the resource and a response from the authoritative user allowing the user to access the resource; and
receiving a notification from the bot indicating that the user is allowed to access the resource.

6. The method of claim 5, wherein:
the response indicates the defined period; and
the notification indicates the defined period.

7. The method of claim 1, wherein assigning the attribute comprises:
notifying at least a second node, associated with the resource, on the private network that the node is assigned the attribute, wherein, upon receiving a request for the resource from the node, the second node determines the node has the attribute assigned thereto and allows the node to access the resource.

8. The method of claim 1, comprising:
distributing to at least a second node, associated with the resource, an access grant indicating nodes assigned the attribute are allowed to access the resource.

9. The method of claim 8, wherein the access grant is one of multiple access grants defining attributes enabling access to resources on the private network.

10. The method of claim 1, comprising:
coordinating with an identity provider to authenticate an identity of a user of the node;
determining other attributes associated with the identity; and
assigning the other attributes to the node, wherein nodes on the private network use the other attributes to determine whether the node is allowed to access other resources.

11. The method of claim 1, wherein removing the attribute comprises:
notifying at least a second node, associated with the resource, on the private network that attributes of the node do not include the attribute, wherein the second node blocks access to the resource by the node in response to determining the attributes of the node do not allow access to the resource.

12. An apparatus for granting access to resources on a private network, the apparatus comprising:
one or more computer‑readable storage media;
one or more processing systems operatively coupled with the one or more computer‑readable storage media; and
program instructions stored on the one or more computer‑readable storage media that, when read and executed by the one or more processing systems, direct the apparatus to:
distribute access rules to nodes on the private network, wherein the access rules indicate which attributes, when assigned to a given node, enable access to which of the resources;
distribute factual attributes about a first node on the private network to other nodes on the private network, wherein the other nodes apply the access rules to the factual attributes to determine a first resource set of the resources to which the first node is allowed access;
in response to being notified that the first node is allowed temporary access to a resource not in the first resource set, inform the other nodes about a control attribute assigned to the first node, wherein a corresponding access rule of the access rules enables access to the resource; and
upon satisfaction of a temporary-access criterion, inform the other nodes that the control attribute is no longer assigned to the first node.

13. The apparatus of claim 12, wherein the program instructions direct the apparatus to:
determine an identity of a user;
determine user attributes of the user corresponding to the identity; and
include the user attributes in the factual attributes.

14. The apparatus of claim 12, wherein the program instructions direct the apparatus to:
determine system attributes of a computing system implementing the first node; and
include the system attributes in the factual attributes.

15. The apparatus of claim 12, wherein the program instructions direct the apparatus to:
receive a message from an authorizing user indicating the first node is allowed the temporary access and providing the temporary-access criterion.

16. The apparatus of claim 12, wherein the temporary-access criterion comprises:
a time limit on how long the first node is allowed the temporary access; or
an event that indicates the temporary access should be ended.

17. The apparatus of claim 12, wherein the program instructions direct the apparatus to:
create the control attribute; and
create the corresponding access rule enabling access to the resource by nodes with the control attribute; and
add the corresponding access rule to the access rules.

18. A method for granting access to resources on a private network, the method comprising:
distributing access grants to nodes on the private network, wherein the access grants define for the nodes which node attributes enable access to which resources;
determining a user of a first node on the private network is requesting access to a resource provided by a second node on the private network, wherein the first node is assigned one or more attributes that do not enable access to the resource according to the access grants;
in response to determining the user is allowed to access the resource until a satisfaction of a criterion, assigning a control attribute to the first node, wherein an access grant of the access grants indicates nodes with the control attribute are allowed to access the resource; and
in response to determining the criterion is satisfied, removing the control attribute from the first node.

19. The method of claim 18, wherein determining the user is requesting the access to the resource comprises:
receiving a notification that the user made a natural language request for the access to the resource over a user-communication channel with another user and the other user granted the access to the resource in a natural language response.

20. The method of claim 18, comprising:
in the second node:
receiving a request for the access to the resource from the first node;
in response to the second node determining the first node is assigned the control attribute and the access grant allows the access to the nodes with the control attribute, providing the access to the resource; and
in response to determining the control attribute has been removed from the first node, stopping the first node from accessing the resource.
